(19) United States
(12) Patent Application Publication
(10) Pub. No.: US 2010/0309489 A1
(43) Pub. Date: Dec. 9, 2010

(54) MEDIA PROCESSING DEVICE AND METHOD OF PRINTING OF RASTER DATA

(76) Inventors: James Ray Bailey, Georgetown, KY (US); Lucas David Barkley, Lexington, KY (US); John Booth Bates, Harrodsburg, KY (US); James Lesesne Bush, III, Lexington, KY (US); Eric David Langevin, Lexington, KY (US); Michael Anthony Marra, III, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/481,217

(22) Filed: Jun. 9, 2009

(51) Int. Cl. G06K 15/02

(52) U.S. Cl. 358/1.5; 358/3.24

(57) ABSTRACT

A method for printing of raster data in a media processing device is disclosed. The method includes identifying an attribute of a set of raster lines of the raster data. The method further includes determining at least one print mode from a plurality of print modes based on the attribute. Each print mode of the plurality of print modes is configured to print the set of raster lines of the raster data. Furthermore, the method includes printing the set of raster lines of the raster data in the at least one print mode.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates generally to media processing devices, and more particularly, to mechanisms for printing raster data in the media processing devices.

2. Description of the Related Art

Media processing devices such as a printer, a photocopier, and the like are commonly used in personal, official or other applications. The media processing devices, specifically printers, are extensively used for printing documents, stored in an electronic form on physical print media such as paper. A typical printer, such as an inkjet printer operates by directing a stream of minute ink droplets onto the paper so as to produce a final image on the paper. The ink is directed through nozzles configured on a printhead (PH) of the printer.

Generally, the printer is used as a peripheral device that is hosted by a system such as personal computer (PC) or any other controller device. The system may provide a data to the printer to print on the physical print media. The data can be in any form such as, but not restricted to, a textual data and an image. The data may be stored in a memory of the printer. The printer may start executing a print operation for a portion of the data, which is interpreted by a processor of the printer.

The data can be a raster data such as a scanned image or a photograph. The raster data includes a grid of cells for storing the data. The smallest discrete unit of the raster data in the grid is denoted by a pixel that displays a unique attribute of the smallest discrete unit. The printer carries out processing of the raster data for obtaining pixel information of the raster data for printing purpose. The pixel information provides information, about the smallest discrete component of the raster data, which is used for printing. The printer may eject ink on the physical print media for each pixel of the raster data in order to provide an impression to each pixel of the raster data. By providing color to each pixel of the raster data, the raster data may be printed on the physical print media. A line drawn in a raster format can be defined by a group of pixels along the length of the line. The group of pixels forms a raster line, and the raster data may be considered as including a plurality of raster lines.

Conventionally, the printer uses a swath-by-swath approach for printing the raster data. A band of ink drops printed at a time is generally referred to as the “swath.” The raster data is printed on the physical print media by performing printing in successive swaths. The printer may print the raster data in various ways such as one pass printing, multi-pass printing, etc. In one pass printing, each horizontal motion of the printhead across the print medium is used to print a portion of the raster data in one single scan. Multi-pass printing is employed by printing overlapping swaths having a partial printing density in each pass, in a process known as “shingling.”

Further ways of printing include 1-pass bidirectional (single pass in both the directions (left to right and right to left) of the raster data), multi-pass bidirectional printing such as 2-pass bidirectional (two passes in both the directions of the raster data), printing with slower carrier speed, etc. For example, black text may be printed by utilizing 1-pass bidirectional printing, and colored images may be printed by utilizing multi-pass bidirectional printing.

Typically, printing of the raster data may lead to various defects irrespective of the ways of printing. Conventionally, such defects occur at a swath boundary that may be due to blending of consecutive swaths together when a printhead of the printer scans the consecutive swaths. An example of such defects may be in form of a horizontal streak at the swath boundary. Such defects may yield poor quality of printed image on the physical print media Additionally, printing lines (especially vertical lines of the grid of the raster data) highlights any bidirectional differences in drop formation. More specifically, there may be differences in thickness of the printed image of the vertical lines in the bidirectional printing. Further, printing of high-density areas (i.e., bold or large texts) stresses nozzle usage of the printhead and causes additional defects such as misting, mottling, etc. Due to the defects described above, the user may need to choose from various predefined print options that may be available to the user, if the user encounters these defects while performing the printing. However, the user may be unable to avoid the trade-off between the printing speed and print quality related to the printing.

Based on the foregoing, there is a need for providing an optimized way for printing of the raster data in the media processing device so as to avoid the various printing defects and in order to maintain the printing quality. Further, there is a need for performing a print operation of the raster data with reduced effort and time requirements from the user's perspective.

### SUMMARY OF THE DISCLOSURE

In view of the foregoing disadvantages inherent in the prior art, the general purpose of the present disclosure is to provide a method for printing of raster data in a media processing device to include all the advantages of the prior art, and to overcome the drawbacks inherent therein.

In one aspect, the present disclosure provides a method for printing of raster data in a media processing device. The method includes identifying an attribute of a set of raster lines of the raster data. Further, the method includes determining at least one print mode from a plurality of print modes based on the attribute. Each print mode of the plurality of print modes is configured to print the set of raster lines of the raster data. Furthermore, the method includes printing the set of raster lines of the raster data in the at least one print mode.

In another aspect, the present disclosure provides a media processing device for printing of raster data. The media processing device includes a processing module and a printing module communicably coupled to the processing module. The processing module is configured to identify an attribute of a set of raster lines of the raster data. Further, the processing module determines at least one print mode from a plurality of print modes based on the identification of the attribute. The printing module is configured to print the raster data by printing the set of raster lines of the raster data. The printing module prints the set of raster lines of the raster data in the at least one print mode.

### BRIEF DESCRIPTION OF THE DRAWINGS

The above-mentioned and other features and advantages of this disclosure, and the manner of attaining them, will become more apparent and the disclosure will be better understood by reference to the following description of embodiments of the disclosure taken in conjunction with the accompanying drawings, wherein:

FIG. 1 is an exemplary block diagram of a media processing device, according to one embodiment of the present disclosure;

FIG. 2 illustrates an exemplary flowchart of method for printing of raster data in the media processing device, according to one embodiment of the present disclosure;

FIG. 3 illustrates an exemplary method for printing of the raster data in the media processing device, embodying the present disclosure;

FIG. 4 illustrates another exemplary method for printing of the raster data in the media processing device, embodying the present disclosure; and

FIG. 5 illustrates another exemplary method for printing of the raster data in the media processing device, embodying the present disclosure.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. In this document, relational terms such as first and second, and the like may be used solely to distinguish one module or action from another module or action without necessarily requiring or implying any actual such relationship or order between such modules or actions. The use of “including,” “comprising,” or “having” and variations thereof herein is meant to encompass the items listed thereafter and equivalents thereof as well as additional items. Unless limited otherwise, the terms “connected,” “coupled,” “disposed” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the present disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the disclosure may be implemented in a software. As such, it should be noted that a plurality of hardware and software-based devices, as well as a plurality of different structural components may be utilized to implement the present disclosure.

The present disclosure provides a method for printing of raster data in a media processing device. The method is performed intelligently to optimize the printing by automating the process of recognizing various attributes related to the raster data, such as presence and absence of white spaces inside the raster data, and thereby avoids any printing defect. The method analyzes raster data and intelligently chooses to print text, including where to break the swath, which direction to print and how many passes are required for printing and thereby provides optimal performance for quality and speed.

The method works on the basis of various print modes that define one or more actions for printing the raster data. The raster data may consist of a set of raster lines. The print modes may provide information related to number of passes and direction of passes required to print the set of raster lines. The print mode further provides information about a particular subset of mono nozzles that may be utilized in the printing of the set of raster lines for optimizing nozzle usage in the media processing device. For example, the top nₜ (nₜ being an integral number) nozzles and the bottom n_{b} (n_{b} being an integral number) nozzles of a plurality of nozzles of the printhead (of the media processing device) may be utilized for printing on alternate swaths of printing of the set of raster lines. Alternatively, another subset of nozzles from a middle portion of the plurality of nozzles may be utilized for printing in order to maximize usage of each nozzle of the plurality of nozzles over time and thereby, to maintain nozzle health.

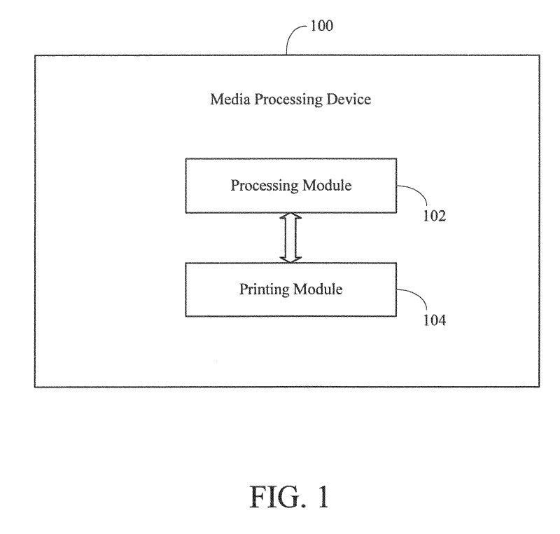

Referring now to the drawings and particularly to FIG. 1, an exemplary block diagram of a media processing device 100 is shown, according to one embodiment of the present disclosure. Media processing device 100 is a printer that prints data, such as the raster data, received from a system such as a personal computer (PC) or any other controller device. The data may include, but is not limited to, a text data and an image. The raster data may include a plurality of raster lines. Each raster line may include a set of pixels of data and each pixel denotes a smallest unit of the raster data. Media processing device 100 includes a processing module 102, and a printing module 104 communicably coupled to processing module 102.

Media processing device 100 may print the raster data by printing successive areas of the raster data in a sequential manner. The raster data may include a set of the raster lines and these lines are printed in a sequential manner in a swath-by-swath basis. Herein one swath of the printing represents an area of the set of raster lines that is printed in a single pass. The present disclosure provides processing of the raster data by the processing module 102 of media processing device 100 before actually printing the raster data on the physical print media.

Processing module 102 identifies an attribute of the set of raster lines of the raster data. The attribute of the set of raster lines of the raster data may include, but is not restricted to, a white space and a raster dot count. Further, processing module 102 may determine at least one print mode dynamically from a plurality of print modes on the basis of the identified attribute. The print mode may define an execution of various operations that are to be carried out in media processing device 100 in order to perform an efficient printing of the set of raster lines. The print mode may be utilized by printing module 104 by printing the set of raster lines in the print mode.

The print mode may define, but is not limited to, at least one of where to break the swath, number of passes required for printing, direction of passes for the printing, an index distance by which the printhead of media processing device 100 needs to be advanced between passes, and a number of nozzles of the printhead required for printing of the set of raster lines. The print mode for printing of the set of raster lines may be selected from the plurality of print modes based on the attribute of the set of raster lines. For example, if the set of raster lines (that are to be printed) includes a white space (the attribute of the set of raster lines), processing module 102 may determine a print mode from the plurality of print modes that defines a printing operation specifically for the presence of white space in the set of raster lines.

It would be apparent to those skilled in the art that processing module 102 may determine more than one print mode (from the plurality of print modes) for the set of raster lines on the basis of the plurality of attributes that are present in the set of raster lines. Printing module 104 prints the set of raster lines in the determined print modes.

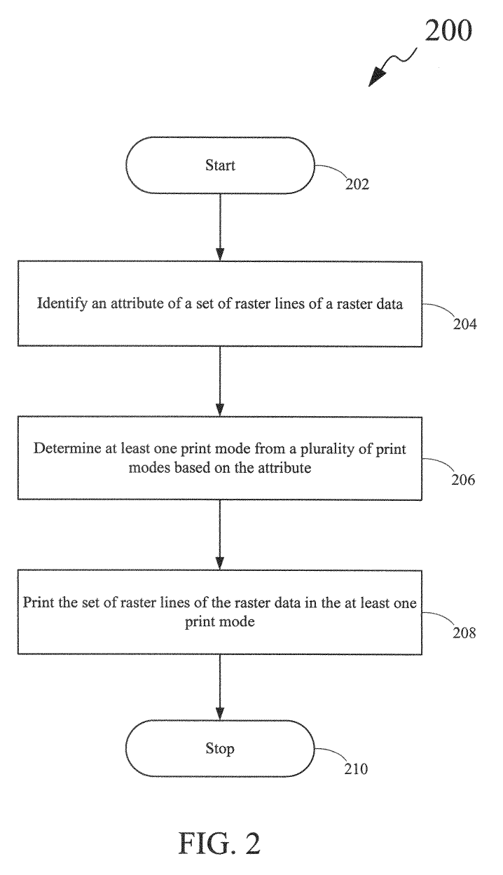

Printing module 102 may print the set of raster lines by directing a stream of minute ink droplets onto the paper so as to produce an impression related to the set of raster data onto the physical print media. The ink is directed through nozzles configured on a printhead (PH) of the printer. Printing module 104 prints the set of raster data in the determined print modes of media processing device 100. A method for performing printing of the raster data in media processing device 100 is described in conjunction with FIG. 2.

Referring now to FIG. 2, an exemplary flowchart of a method 200 for printing of raster data in a media processing device is shown, according to one embodiment of the present disclosure. The method is performed in the media processing device, such as media processing device 100 (hereinafter referred to as “the media processing device”). The order in which method 200 is described is not intended to be construed as a limitation, and any number of the described blocks of the flowchart may be combined in any order to implement method 200, or an alternative method.

Method 200 starts at block 202. At block 204, method 200 identifies an attribute of a set of raster lines of a raster data. The attributes may include, but is not limited to, presence or absence of a white space and a raster dot count. In an embodiment, the presence or absence of white space may refer to presence or absence of white space at a particular raster line. Further, the raster dot count may denote a density or number of raster dots in the raster data. The white space at a particular raster line may be identified via blank or low value of the raster dot count at the raster lines. In one embodiment, if at the raster line, number of raster dot count is less than a particular threshold count, the presence of the white space may be determined at the raster line. The attribute of the set of raster lines may be determined by a processor of the media processing device, such as processing module 102.

At block 206, the method determines at least one print mode from a plurality of print modes based on the attribute. In one embodiment, the attribute may be compared with a predefined threshold value of the attribute to determine a print mode to print the set of raster lines. The print mode defines an action to be taken for printing the set of raster lines in successive swaths. Accordingly, different swaths of the set of raster lines may be printed with same or different print modes depending upon the identified attribute.

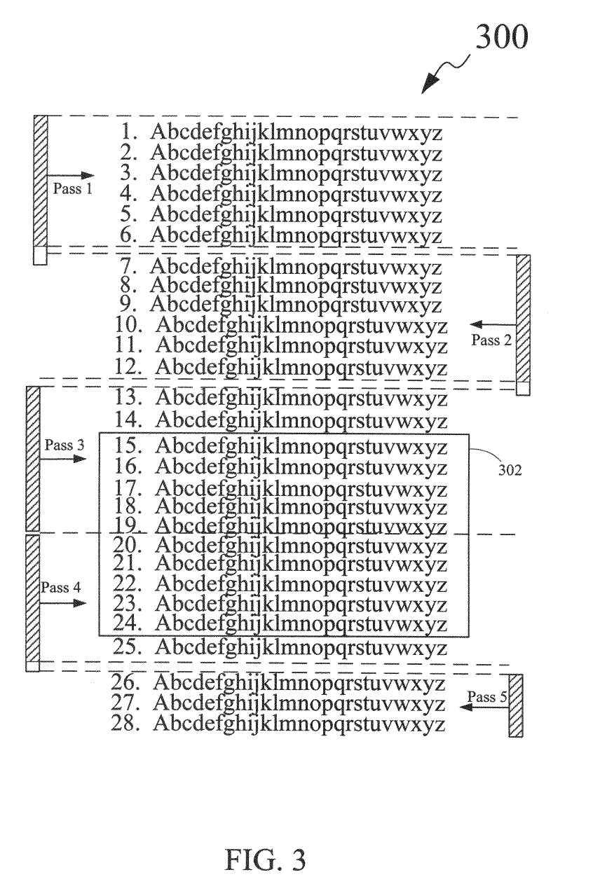

In one embodiment, the printing of the set of raster lines is performed in successive swaths. Method 200 selects a swath boundary by first analyzing an area of the set of raster lines that may be printed at a time. In a specific print mode, the swath boundary may be broken at a portion of the set of raster lines where the white space is identified. Selection of the swath boundary may also require that a number of nozzles of the printhead that are used for printing a particular swath should be more than a threshold number of nozzles. Accordingly, in this print mode, if the set of raster lines includes a white space (if the white space is present at a portion in the set of raster lines, i.e. the attribute of the portion of the set of raster lines is a white space) and the number of nozzles required for printing of the swath of the set of raster lines is greater than a threshold number of nozzles, such print mode of the plurality of print modes may be selected, which breaks the swath of printing at the portion of the set of raster lines where the white space is present. The threshold number of nozzles allows a limit to potential speed reduction of the printing if not all nozzles of the media processing device are used for the printing. In this print mode, it may be defined that the printing should be performed in a one-pass bidirectional printing of the swath. An example of such print mode is further explained in conjunction with FIG. 3, which is described later.

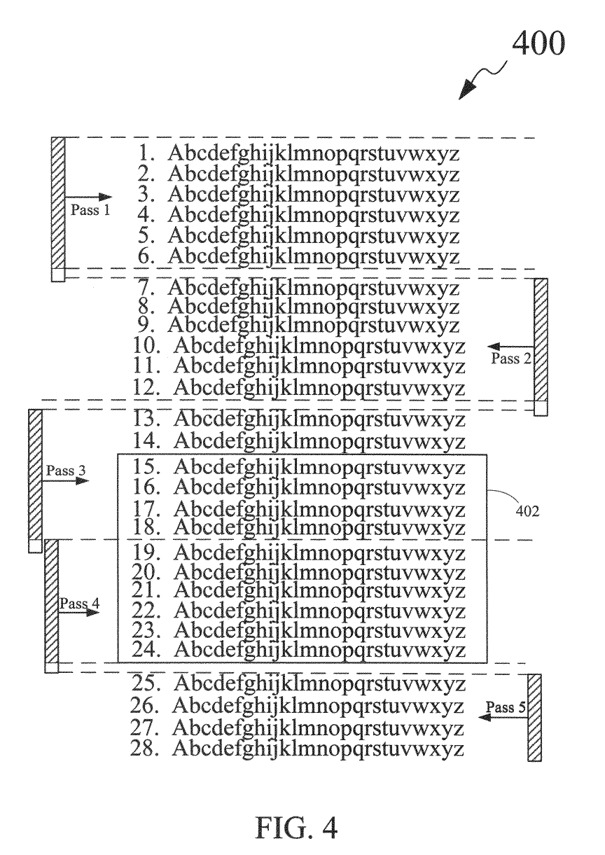

Further, in cases when the white space is not identified in the set of raster lines, at least one of a first print mode, a second print mode, and a third print mode of the plurality of print modes may be selected for the printing. The cases where the white space may not be present in an area of the set of raster lines include, but are not limited to, table border, a table with text, or a vertical line, or any continuous text spanning in more than one swath. Furthermore, the first print mode, the second print mode, and the third print mode may be utilized by the media processing device to mask any bidirectional defect and swath boundary defects. The bidirectional effect and the swath boundary defect are explained later in with reference to FIGS. 3 and 4.

The first print mode may include performing a two-pass bidirectional printing of the set of raster lines. The two-pass bidirectional printing may be performed by advancing the printhead of the media processing device by an index distance between passes of the two-pass bidirectional printing. For example; the two-pass bidirectional printing may be performed with a half (½) printhead media advance or a small (or no) media advance between passes. Further, in the second print mode, a one-pass unidirectional printing may be performed for one or more swaths of printing. More specifically, direction of the printing remains the same in successive swaths of printing in the second print mode.

The third print mode may include performing a one-pass bidirectional printing of the set of raster lines. The third print mode may be utilized for providing the fastest printing possible. It would be apparent to those skilled in the art that by performing the printing in a single pass and also in both directions in the third print mode provides a mode with an emphasis on print speed. Further, the one-pass bidirectional printing in the third print mode may utilize printing with at least a subset of nozzles from the plurality of nozzles in the case when there are visual defects associated with end nozzles of the printhead. Typically, such visual defects are associated with defective nozzles that should be found at the end of the printhead.

In one embodiment of the present disclosure, the first print mode, the second print mode and the third print mode may be used while placing the swath boundary in an area of the set of raster lines having the lowest number of raster dots and the number of nozzles used for printing the swath is greater than the threshold number of nozzles. This embodiment may be used for printing the raster data containing a table with text characters and thus avoiding a swath boundary within the text characters of the set of raster lines.

In another embodiment, the first print mode, the second print mode and the third print mode may be used while placing the swath boundary in an area of the set of raster lines having highest number of raster dots.

Further, the plurality of print modes includes a fourth print mode. The fourth print mode defines that printing of a particular area of the set of raster lines should be performed in a plurality of passes. The fourth print mode may be selected for the printing when the set of raster lines contains relatively large text. The media processing device may identify a large text (that can be fitted in a single swath) by identifying a number of contiguous raster lines in the set of raster lines of the raster data. Herein, the term ‘contiguous raster lines’ represent raster lines that share same attributes, such as same raster dot counts. For example, a text written in a bold pattern may have a number of dot counts greater than a threshold count in those raster lines that include at least a part of the text.

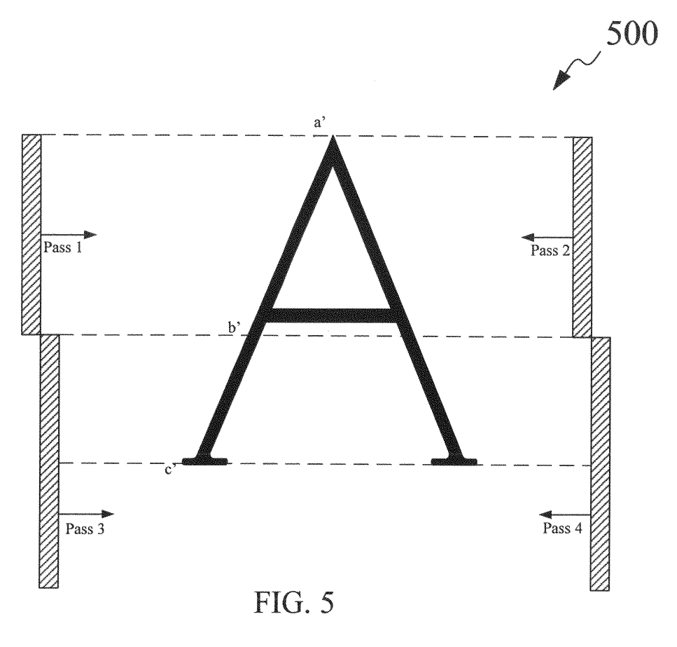

In one embodiment, such large texts that fit in a single swath can be identified on the basis of the number of contiguous raster lines that have raster dot counts greater than the threshold count. A presence of the large text is further shown and explained in conjunction with FIG. 5. Further, a number of passes required for the printing of such texts may be determined based on the number of raster dots in the contiguous raster lines. Printing performed in the fourth mode, i.e. printing in multiple passes, may reduce effects such as mottling by allowing the ink to better absorb into the print medium.

At block 208, method 200 prints the set of raster lines of the raster data in the at least one print mode determined from the plurality of print modes. The set of raster lines may be printed in the media processing device by using a printing module, such as the printing module 104 (hereinafter referred to as “the printing module”). The set of raster lines may get printed in the determined print mode (as determined at block 206). The set of raster lines may be printed by utilizing the print mode from the plurality of print modes depending on primary errors such as the bidirectional defect and the swath boundary defect (that may be pre-defined) expected and/or the visibility of the primary errors in the printed output. More specifically, at least one print mode from the plurality of print modes may be identified for the printing of the set of raster lines depending upon the attributes of the set of raster lines.

Further, the printing of the set of raster lines based on the identified at least one print mode may require switching between the determined print modes based on attributes of the set of raster lines. Without limiting the scope of the present disclosure, in an example, when an area of very large text that spans more than one swath in the set of raster lines is printed according to the fourth print mode, and if the adjacent area of the large text also includes some part of the large text, the adjacent area will also be printed in the fourth print mode, even if the adjacent area has some other attributes such as presence of the white space in the adjacent area. However, it would be apparent to those skilled in the art that rules for switching between the modes for the printing of the set of raster lines may be customized.

Additionally, the printing may include text optimization through color printing. Typically, four different color inks (cyan, magenta, yellow, and black) are used by the media processing device to print the range of colors contained in the set of raster lines. A CMY nozzle (that represents cyan, magenta and yellow colors) usage can be dynamically optimized based on the monochrome (K) nozzle usage. For example, matching nozzle usage (i.e., use horizontally corresponding sets of nozzles for CMY and K) may be optimal. Alternatively, using a larger subset of CMY nozzles may results in optimal performance, which would be beneficial in areas of the set of raster lines where CMY drops are horizontally adjacent to the identified white space in the K areas of the set of raster lines.

The method 200 is terminated at block 210.

FIG. 3 is a schematic diagram illustrating a method 300 for printing the raster data in the media processing device, embodying the present disclosure. References will be made to the FIGS. 1 and 2 for the purpose of description of FIG. 3. The raster data, as shown in FIG. 3, includes text arrays and a border 302. FIG. 3 depicts the raster data including the set of raster lines having text arrays ranging from text line 1 to text line 28.

FIG. 3 shows pass 1 that prints the first swath (first six text lines, from line numbers 1 to 6) of the raster data in a left to right direction by utilizing top n1 nozzles of a printhead of the media processing device. The media processing device may identify a presence of a white space after text lines 6 and breaks the swath below the sixth line of the raster data. The presence of the white space (i.e., a blank raster line) may be identified by the attribute such as the low raster dot count below the text line 6. Accordingly, a first swath area for the printing of the set of raster lines may be defined between text lines 1 to 6. It would be apparent to a person skilled in the art that a selection of the swath area also requires a consideration of optimum printing yield. For example, white spaces may also be present below text lines 3, 4, and 5, but the swath area for the pass 1 is selected starting from text line 1 to text line 6 in order to provide optimum printing area in one swath.

Similarly, next swath of the printing covers text line 7 to text line 12 of the raster data, and is performed as pass 2 in right to left direction, as shown in the FIG. 3. In the pass 2, the print media is advanced to align a swath area of the printing to the top of the printhead. The pass 2 is carried out by utilizing top n2 nozzles of the printhead for printing the swath area (between line numbers 7 and 12). It would be apparent to those skilled in the art that the n1 nozzles and n2 nozzles may be selected from entire nozzles of the printhead by taking optimal usage of each nozzle into consideration.

Further regarding pass 2, the print media is again advanced to align top of the printhead to next swath of the printing. Further, it may be determined that the white space is present below text line 13. However, the white space (below text line 13) is too short to be considered in a single swath of printing. Accordingly, a next pass (pass 3) may be considered from text lines 13 to 19 in one PH size (which may be a maximum swath height in a swath boundary) due to the presence of border 302. A next swath covering text lines 13 to 19 are scanned in pass 3 in left to right direction. Each of the plurality of nozzles of the printhead may be used in the pass 3. In FIG. 3, a swath boundary defect may arise as shown in the pass 3, where a portion of the text array in text line 19 has not been completely scanned in the pass 3. So to avoid the swath boundary defect, a print mode such as the second print mode (as explained earlier), may be utilized for the printing that can mask the swath boundary defect of the raster data. Accordingly, the print mode for the next swath, i.e. the pass 4, is selected in the same direction as of the pass 3, i.e. left to right, and uses top n4 nozzles of printhead. Subsequently, the print media is advanced by an index equivalent to full printhead (PH) size and the swath boundary is broken below text line 25 where the white space is determined. Further, after completion of the pass 4 (left to right), printing of the remaining text lines 26 to 28 may be performed in right to left direction in pass 5, as shown in FIG. 3.

Solution to the swath boundary defect is further explained in conjunction with FIG. 4, in accordance with another embodiment of the present disclosure. FIG. 4 is a schematic diagram illustrating a method 400 for printing the raster data in the media processing device, embodying the present disclosure. The description of the FIG. 4 may be understood based on the foregoing explanation in conjunction with FIGS. 1, 2 and 3. The raster data, as shown in FIG. 4, includes text arrays and border 402. Border 402 is similar to border 302 as shown in FIG. 3. FIG. 4 depicts the raster data including the plurality of raster lines having text arrays from text line 1 to text line 28. The raster data may be printed in the media processing device in at least one print mode that may be determined based on attributes of the raster data. An attribute of the raster data, as shown in the FIG. 4, is the absence or presence of the white space, which serves as a basis to select the at least one print mode for the printing of the set of raster lines.

Text lines 1 to 12 are printed in the same manner in pass 1 and pass 2, as explained in conjunction with FIG. 3. After performing pass 2, the print media is advanced to align top of the printhead to next swath, i.e., pass 3. Herein, a print mode is chosen to avoid the swath boundary defect instead of masking the swath boundary defect (as explained in FIG. 3). For avoiding the swath boundary defect, in one embodiment, a print mode defines that the swath boundary should be broken at a portion of the set of raster lines before a particular text line, if the particular text line may not be scanned completely in a single swath. For example, if text line 19 may not be scanned completely, the swath boundary will range only between text lines 13 and 18. Accordingly, the pass 3 is performed for text lines 13 to 18 of the raster data (as opposed to between text lines 13 and 19 in pass 3 of FIG. 3). The pass 3 is performed in left to right direction by utilizing top n3 nozzles of the printhead.

It may also be inferred that in such cases, the swath boundary is placed at an area of the raster data having minimum number of the raster dots before the raster line where swath boundary defect is likely to appear. Further, when more than one raster line includes the same minimum number of raster dots, a raster line among the more than one raster lines may be chosen, which may provide the largest print swath, i.e., print area coverage. However, in another embodiment of the present disclosure, the swath boundary may also be placed at an area having highest number of raster dots in the raster data. For example, the swath boundary may be placed at a horizontal line, such as a boundary line of a border or a table, in the raster data.

Thereafter, pass 4 is utilized to print text lines 19 to 24 in the same direction of pass 3, i.e., left to right direction. A swath boundary for the pass 4 is defined from text line 19 to text line 24. A white space is identified below text line 24 and the printing of text lines 19 to 24 requires utilizing only top n4 nozzles of the printhead. Further, the print media may be advanced to align top of the printhead to next area of printing, i.e, to text lines 25 to 28. Text lines 25 to 28 are printed under pass 5 in right to left direction.

FIG. 5 illustrates an exemplary method 500 for printing of the raster data in the media processing device embodying the present disclosure. The FIG. 5 illustrates 2-pass printing for a raster data containing a text having the text size greater than a threshold text size. In other words, the FIG. 5 depicts printing for the cases when the raster data include very large text. In such cases, a particular print mode, such as the fourth print mode, may be determined from the plurality of print modes. The FIG. 5 may be understood based on the foregoing explanation in conjunction with FIG. 1 and FIG. 2.

FIG. 5 depicts a large text containing a letter ‘A’ in bold font. For the printing of the large and bold text, the fourth print mode may be selected, which defines that the printing should be performed in multiple passes. The number of passes may be determined by identifying the attribute, such as the raster dot count in contiguous raster lines m the raster data. The contiguous raster lines represent raster lines which are adjacent and each has a similar attribute pattern, for example, each raster line has same raster dot count that is more than a threshold dot count. The contiguous raster lines including more number of raster dot counts may require more number of passes for the printing.

However, the FIG. 5 shows 2-pass printing for a portion of the text. Each of the two passes may include a 50% shingling process in which 50% of the pixels of the portion of the raster data may be printed. Each pass may include shingling of every pixel in a particular sequence, for example, first pass of the two passes may include shingling of evenly placed pixels in the raster data and a second pass of the two passes may include shingling of odd placed pixels of the raster data.

FIG. 5 shows pass 1 and pass 2 for a first portion (first set of raster lines) of the raster data. The first portion of the raster data covers an area a′ to b′ of the raster data. Each of the pass 1 and the pass 2 utilizes all nozzles of the plurality of nozzles of the printhead for printing of the first portion. The pass 1 performs 50% shingling in left to right direction. The pass 2 performs remaining 50% shingling in right to left direction without any print media advance between the pass 1 and the pass 2.

After completion of the pass 1 and the pass 2, the print media is advanced to align the top of the printhead to a second portion (second set of raster lines) of the raster data covering an area b′ to c′. Similar to the printing of the first portion (a′ to b′), the second portion is printed in two passes: pass 3 and pass 4. The pass 3 performs 50% shingling in a left to right direction by utilizing top n1 nozzles from the plurality of nozzles of the printhead. The pass 4 performs 50% shingling in a right to left direction by utilizing top n2 nozzles from the plurality of nozzles of the printhead. The top n1 nozzles may be a first subset of the topmost nozzles of the plurality of nozzles, and the top n2 nozzles may include a second subset of nozzles, subsequent to the first subset of nozzles, of the plurality of nozzles.

In FIG. 5, only 2 passes are shown to print the first portion and the second portion, and it should not be considered limiting. It would be apparent to those skilled in the art that more than two passes may be used for printing of such large texts depending upon the raster dot counts of the contiguous raster lines.

The foregoing description of several methods and an embodiment of the disclosure have been presented for purposes of illustration. It is not intended to be exhaustive or to limit the disclosure to the precise steps and/or forms disclosed, and obviously many modifications and variations are possible in light of the above description. It is intended that the scope of the disclosure be defined by the claims appended hereto.

What is claimed is:

1. A method for printing of raster data in a media processing device, the method comprising:
identifying an attribute of a set of raster lines of the raster data;
determining at least one print mode from a plurality of print modes based on the attribute, each print mode of the plurality of print modes configured to print the set of raster lines of the raster data; and
printing the set of raster lines of the raster data in the at least one print mode.

2. The method of claim 1, wherein the attribute of the set of raster lines of the raster data is at least one of a white space at each raster line of the set of raster lines and a raster dot count of each raster line of the set of raster lines.

3. The method of claim 1, wherein printing the set of raster lines in the at least one print mode comprises breaking a swath of printing at a portion of the set of raster lines of the raster data, when the attribute of the set of raster lines represents a white space and a number of nozzles required for the printing of the set of raster lines is greater than a threshold number of nozzles.

4. The method of claim 3, further comprising performing one pass bidirectional printing of the set of raster lines.

5. The method of claim 1 wherein printing the set of raster lines in the at least one print mode comprises at least one of:
printing in a first print mode, the first print mode comprising performing a two-pass bidirectional printing of the set of raster lines, wherein a printhead of the media processing device is advanced by an index distance between passes of the two-pass bidirectional printing;
printing in a second print mode, the second print mode comprising performing a one-pass unidirectional printing of the set of raster lines in one or more swaths of printing; and
printing in a third print mode, the third print mode comprising performing a one-pass bidirectional printing of the set of raster lines, wherein at least a subset of nozzles of the plurality of nozzles of the printhead is utilized for the printing of the set of raster lines, and
wherein the attribute of the set of raster lines represents absence of a white space in the set of raster lines.

6. The method of claim 5, wherein the printing is performed by placing a swath boundary in an area of the set of raster lines having the lowest number of raster dots, and wherein a number of nozzles used for the printing is greater than a threshold number of nozzles.

7. The method of claim 5, wherein the printing is performed by placing a swath boundary in an area of the set of raster lines having the highest number of raster dots.

8. The method of claim 1, wherein the at least one print mode comprises printing in a fourth print mode, the fourth print mode comprising performing printing in a plurality of passes when the attribute of the set of raster lines represents a text size greater than a threshold text size.

9. The method of claim 8, wherein the plurality of passes is determined by:
identifying a number of raster dots in contiguous raster lines in the set of raster lines of the raster data; and
determining a number of passes of the plurality of passes for printing the set of raster lines of the raster data based on the identification of the number of raster dots in the contiguous raster lines.

10. A media processing device for printing of raster data, the media processing device comprising:
a processing module configured to
identify an attribute of a set of raster lines of the raster data, and
determine at least one print mode from a plurality of print modes based on the identification of the attribute; and
a printing module communicably coupled to the processing module, the printing module configured to print the raster data by printing the set of raster lines of the raster data, the printing module printing the set of raster lines of the raster data in the at least one print mode.

11. The media processing device of claim 10, wherein the attribute of the set of raster lines of the raster data is at least one of a white space at each raster line of the set of raster lines and a raster dot count of each raster line of the set of raster lines.

12. The media processing device of claim 10, wherein the printing module is configured to print the raster data in the at least one print mode by breaking a swath of printing at a portion of the set of raster lines of the raster data, when the attribute of the set of raster lines represents a white space and a number of nozzles required for the printing of the set of raster lines is greater than a threshold number of nozzles.

13. The media processing device of claim 12, wherein the printing module is further configured to perform a one pass bidirectional printing of the set of raster lines.

14. The media processing device of claim 10, wherein the plurality of print modes comprises:
a first print mode, the first print mode comprising performing a two-pass bidirectional printing of the set of raster lines, wherein a printhead of the media processing device is advanced by an index distance between passes of the two-pass bidirectional printing;
a second print mode, the second print mode comprising performing a one-pass unidirectional printing of the set of raster lines in one or more swaths; and
a third print mode, the third print mode comprising performing a one-pass bidirectional printing of the set of raster lines, wherein at least a subset of nozzles of the plurality of nozzles of the printhead is utilized for the printing of the set of raster lines.

15. The media processing device of claim 14, wherein the printing module is configured to print in at least one of the first print mode, the second print mode and the third print mode, when the attribute of the set of raster lines represents absence of a white space in the set of raster lines.

16. The media processing device of claim 14, wherein the printing module is further configured to perform printing in at least one of the first print mode, the second print mode and the third print mode by placing a swath boundary in an area of the set of raster lines having the lowest number of raster dots, and wherein a number of nozzles used for the printing is greater than a threshold number of nozzles.

17. The media processing device of claim 14, wherein the printing module is further configured to perform printing in at least one of the first print mode, the second print mode and the third print mode by placing a swath boundary in an area of the set of raster lines having the highest number of raster dots.

18. The media processing device of claim 10, wherein the plurality of print modes comprises a fourth print mode, the fourth print mode comprising performing printing in a plurality of passes when the attribute of the set of raster lines represents a text size greater than a threshold text size.

19. The media processing device of claim 18, wherein the processing module is configured to determine the plurality of passes by:
identifying a number of raster dots in contiguous raster lines in the set of raster lines of the raster data; and
determining a number of passes of the plurality of passes for printing the set of raster lines of the raster data based on the identification of the number of raster dots in the contiguous raster lines.
